(19) United States
(12) Patent Application Publication
(10) Pub. No.: US 2005/0254846 A1
(43) Pub. Date: Nov. 17, 2005

(54) Apparatus and method for fixing an image

(76) Inventors: Jun Yura, Kanagawa (JP); Koichi Kato, Kanagawa (JP); Hiroshi Nakai, Kanagawa (JP); Kazumi Suzuki, Kanagawa (JP); Kei Yasutomi, Kanagawa (JP); Hideki Kosugi, Kanagawa (JP); Hirokatsu Suzuki, Chiba (JP); Ichiro Kadota, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/128,363

(22) Filed: May 13, 2005

(30) Foreign Application Priority Data
May 13, 2004 (JP) 2004-142992

(51) Int. Cl. G03G 15/20

(52) U.S. Cl. 399/67; 399/70

(57) ABSTRACT

An apparatus including and a method using a fixing device including a fixing member, a pressure member, a heater, and a pressure controller. The fixing member and the pressure member face with each other to form a nip. The heater heats a surface of the fixing member when the fixing member rotates. The pressure controller is configured to change a pressure generated at the nip, according to an operation of the fixing device.

This patent specification is based on and claims priority to Japanese patent application No. 2004-142992 filed on May 13, 2004, in the Japanese Patent Office, the entire contents of which are hereby incorporated herein by reference.

### FIELD OF THE INVENTION

The following disclosure relates generally to an apparatus and method for fixing an image.

### BACKGROUND

An image forming apparatus is usually provided with a fixing device for fixing a toner image on a recording medium by heat and pressure. For example, a fixing roller having a heater inside and a pressure roller are provided to form a nip. When a recording medium passes through the nip, a toner image on the recording medium is heated by the heater through the fixing roller, and fixed onto the recoding medium by a pressure generated at the nip.

Recently, to reduce the warm-up time required to heat the fixing roller, a fixing roller having a low heat capacitance has been implemented with an external heater. The external heater heats the surface of the fixing roller, which constantly rotates, at a position away from the nip.

However, the heat applied to the fixing roller may be transmitted to the other members in the fixing apparatus, such as the pressure roller in contact with the fixing roller, thus causing a large amount of energy loss.

Further, the rotation of the fixing roller may accelerate wear of the surface of the fixing roller, or it may increase electricity consumption.

### SUMMARY OF THE INVENTION

Exemplary embodiments of the present invention include a fixing device for use in an image forming apparatus.

In an exemplary embodiment, the fixing device includes a fixing member, a pressure member, a heater, and a pressure controller. The fixing member and the pressure member face with each other to form a nip. The heater is configured to heat a surface of the fixing member when the fixing member rotates. The pressure controller is configured to change a pressure generated at the nip, according to an operation of the image fixing device.

In an exemplary embodiment, the fixing device includes a controller, a fixing member, a pressure member, a heater, and a pressure controller.

The controller is configured to switch operation modes of the fixing device, including a waiting mode and an operating mode. The fixing member is configured to rotate in the operating mode. The pressure member, facing the fixing member, forms a nip with the fixing member. The heater is configured to heat a surface of the fixing member in the operating mode. The pressure controller is configured to change a pressure generated at the nip when the operation modes are switched.

In addition to the above-described fixing devices, this patent specification may be implemented in many other ways, as will be apparent to those skilled in the art, without departing from the spirit or scope of the appended claims and the following disclosure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic side view illustrating a part of an image forming apparatus according to an exemplary embodiment of the present invention;

FIG. 2 is a schematic side view illustrating a fixing device according to an exemplary embodiment of the present invention;

FIG. 3 is a perspective view illustrating a part of the fixing device shown in FIG. 2;

FIG. 4 is a schematic side view illustrating an exemplary structure of the fixing roller shown in FIG. 2;

FIG. 5 is a schematic side view illustrating an exemplary structure of the pressure roller shown in FIG. 2;

FIG. 6 is a schematic side view illustrating a fixing device according to an exemplary embodiment of the present invention;

FIG. 7 is a schematic side view illustrating a fixing device according to an exemplary embodiment of the present invention;

FIG. 8 is a schematic side view illustrating a fixing device according to an exemplary embodiment of the present invention;

FIG. 9 is a schematic side view illustrating a fixing device according to an exemplary embodiment of the present invention;

FIG. 10 is a schematic side view illustrating a fixing device according to an exemplary embodiment of the present invention; and

FIG. 11 is a schematic side view illustrating a fixing device according to an exemplary embodiment of the present invention.

### DETAILED DESCRIPTION OF EXEMPLARY EMBODIMENTS

In describing preferred embodiments illustrated in the drawings, specific terminology is employed for clarity. However, the disclosure of this patent specification is not intended to be limited to the specific terminology selected and it is to be understood that each specific element includes all equivalents that operate in a similar manner.

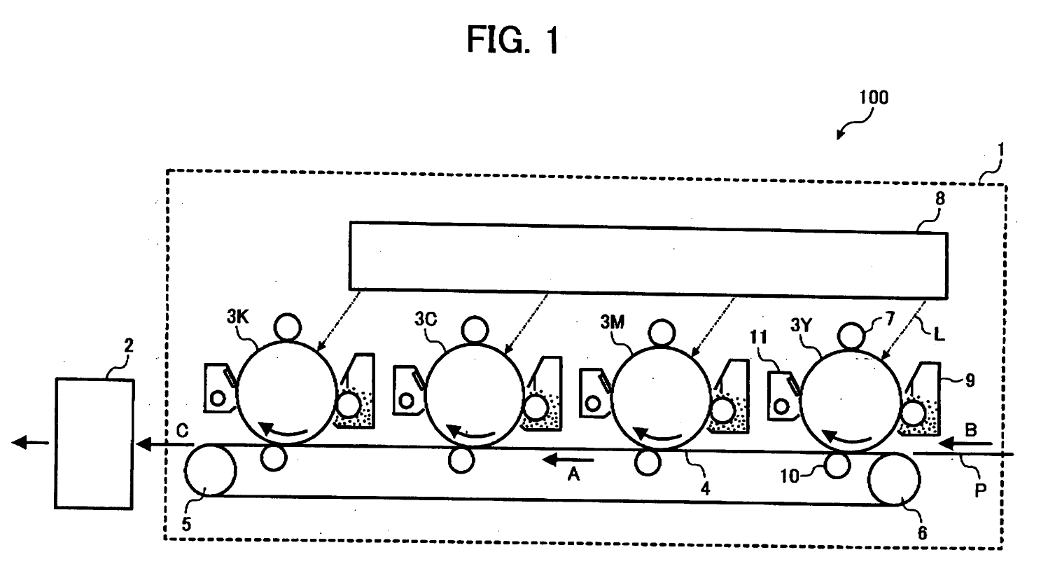

Referring now to the drawings, wherein like reference numerals designate identical or corresponding parts throughout the several views, FIG. 1 illustrates an image forming apparatus 100 according to an exemplary embodiment of the present invention.

In FIG. 1, a selected portion of the image forming apparatus 100, including an image forming device 1 and a fixing device 2, is shown.

The image forming device 1 forms a toner image on a recording medium. The image forming device 1 includes a writing unit 8, first to fourth image carriers 3Y, 3M, 3C, and 3K, an intermediate transfer belt 4, a first roller 5, and a second roller 6.

The first to fourth image carriers 3Y to 3K are arranged side by side. The intermediate transfer belt 4 is provided in parallel to the first to fourth image carriers 3Y to 3K. The first roller 5 and the second roller 6 drive the intermediate transfer belt 4 in the direction indicated by the arrow A.

Each of the first to fourth image carriers 3Y to 3K forms a toner image in a substantially similar manner. By way of example, an image forming operation for forming a yellow toner image is explained.

The first image carrier 3Y, which rotates clockwise in the view depicted in FIG. 1, is uniformly charged by a charging roller 7. The writing unit 8 irradiates a modulated laser beam L onto the charged surface of the first image carrier 3Y. This forms a latent image on the first image carrier 3Y. The latent image is developed by a developer 9 into a yellow toner image.

The intermediate transfer belt 4 receives a recording medium, such as paper P, which is transferred in the direction indicated by the arrow B. The paper P is further carried by the intermediate transfer belt 4 in the direction A. When the paper passes through a nip formed between the first image carrier 3Y and a transfer roller 10, which faces the first image carrier 3Y, a voltage having a polarity opposite to the charged polarity of the roller 7 is applied. As a result, the yellow toner image formed on the first image carrier 3Y is transferred onto the paper P. The residual toner remaining on the first image carrier 3Y is removed by a cleaner 11.

A magenta toner image, a cyan toner image, and a black toner image are formed respectively on the second image carrier 3M, the third image carrier 3C, and the fourth image carrier 3K. Each of the toner images is transferred to the paper P sequentially. The paper P having the composite toner image of four colors is further transferred toward the fixing device 2 in the direction indicated by the arrow C.

The fixing device 2 fixes the toner image onto the paper P. After this fixing operation, the paper P is transferred to a discharging roller (not shown) to be discharged onto an output tray (not shown). Alternatively, the paper P may be reversed to the other side of the belt 4 by a reversing unit (not shown), for another image forming operation.

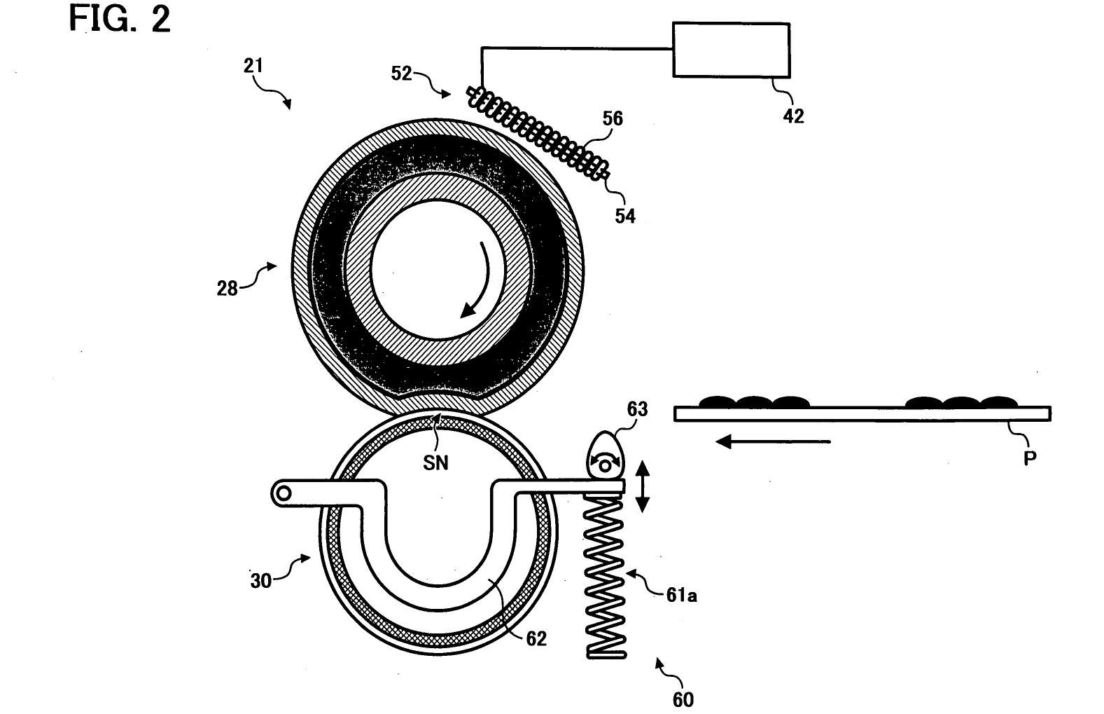

Now, referring to FIGS. 2 to 11, exemplary structures of the fixing device 2 are explained.

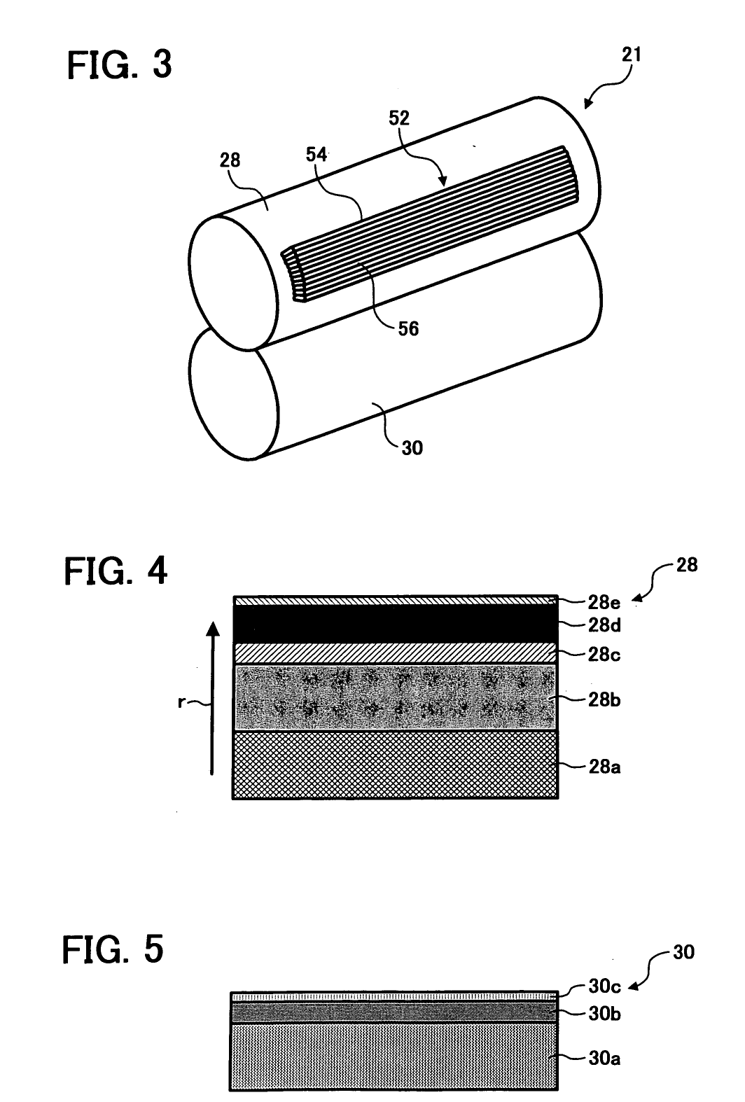

As shown in FIGS. 2 and 3, the fixing device 21 includes a heater 52, a controller 42, a fixing roller 28, a pressure roller 30, and a pressure controller 60.

The heater 52 preferably has a length of about 70 mm in the direction nearly parallel to the circumferential direction of the fixing roller 28. However, many lengths and shapes can be used. The heater 52 may have a sleeve-like shape, extending in the axial direction of the fixing roller 28 (FIG. 3). In this exemplary embodiment, the heater 52 includes a coil supporter 54, and a coil 56 wound around the coil supporter 54. The coil supporter 54 has a rod-like shape, and is fixed at a predetermined position of the fixing device 21. In one embodiment, the coil 56 is preferably implemented by a Litz wire.

The controller 42 may include any kind of processor capable of controlling the fixing device 21. For example, the controller 42 controls the heater 52, or a drive source (not shown), such as a motor or an actuator, for driving the fixing roller 28 or the pressure controller 60. In this exemplary embodiment, the controller 42 is implemented by a printer controller of the image forming apparatus 100, which is a microcomputer including a CPU (central processing unit), a ROM (read only memory), and/or a RAM (random access memory) or other memory, and an I/O (input/output) interface.

The fixing roller 28 is configured to transmit heat from the heater 52 to the paper P passing through the nip SN formed between the fixing roller 28 and the pressure roller 30. The fixing roller 28 may be made of a plurality of layers formed one above (outside) the other. In this exemplary embodiment, as shown in FIG. 4, the fixing roller 28 includes a core 28a, a heat absorbing layer 28b, a heat emitting layer 28c, an elastic layer 28d, and a releasing layer 28e, from the inside to the outside, as indicated by the arrow r.

The core 28a is preferably made of metal, such as aluminum or steel, sufficiently rigid to prevent deflection of the fixing roller 28. Alternatively, the core 28a may be made of glass or ceramics. The thickness of the core 28a is preferably 2 mm to 3 mm; however, it is not limited to these dimensions. Further, the core 28a may have an outer radius of 50 mm; however, it is not limited to this dimension.

The heat absorbing layer 28b reduces heat transfer from layer 28c to the core 28a. The heat absorbing layer 28b is preferably made of foamed silicone rubber having a hardness of 5 to 50 based on the JIS-A standard. Alternatively, any kind of heat resistant material, such as elastomeric material including fluorocarbon rubber, may be used. Further, the thickness of the heat absorbing layer 28b is preferably around 4 mm; however, it is not limited to this size.

The heat emitting layer 28c is typically made of magnetic or nonmagnetic metal. Preferably, magnetic stainless steel such as SUS430 and SUS410, iron, or nickel may be used. Alternatively, an alloy based on any one of the above-mentioned metals may be used. The thickness of the heat emitting layer 28c is preferably between 0.05 mm and 0.5 mm. However, other materials and dimensions may be used.

The elastic layer 28d is typically made of heat resistant elastomeric material, such as silicon rubber or fluorocarbon rubber, for example. Preferably, any kind of material capable of transmitting a heat from the heat emitting layer 28c to the surface of the fixing roller 28 may be used. To increase heat conductivity, filler metal may be combined with one or both of layers 28c and 28d. The thickness of the elastic layer 28d is preferably between 0.2 mm to 2 mm. The hardness of the elastic layer 28d is preferably below 30 based on the JIS-A standard.

The releasing layer 28e is optionally provided to increase releasability of the fixing device 28, and is preferably made of fluorocarbon resin such as PFA (Perfluoroalkoxy) and PTFE (PolyTetraFluoroEthylene), silicon resin, or silicon rubber. The thickness of the releasing layer 28e is preferably between 10 μm and 80 μm, but other dimensions may be used.

The pressure roller 30, which faces the fixing roller 28, forms the nip SN with the fixing roller 28. The pressure roller 30 is made of a plurality of layers formed one outside the other. In one exemplary embodiment, as shown in FIG. 5, the pressure roller 30 includes a core 30a, an elastic layer 30b, and a releasing layer 30c, from the inside to outside, respectively.

The core 30a may be made of metal, such as aluminum or steel. The thickness of the core 30a is preferably between 0.4 mm and 0.8 mm. The core 30a has an outer radius of 30 mm to 40 mm; however, it is not limited to these dimensions.

The elastic layer 30b may be made of silicon rubber, having a hardness of 30 to 60 based on the JIS-A standard, for example. The thickness of the elastic layer 30b is preferably between 0.2 mm and 1 mm.

The releasing layer 30c is optionally provided to increase releasability of the pressure roller 30, and is preferably made of fluorocarbon resin, having a typical thickness of about 50 μm, for example.

The pressure controller 60 is capable of controlling a pressure generated at the nip SN. Further, the pressure controller 60 may control a position of the nip SN, i.e., the pressure controller may control the distance between the fixing roller 28 and the pressure roller 30.

As shown in FIG. 2, the pressure controller 60 includes a pressure spring 61a, a roller supporter 62, and a cam 63. The cam 63 is rotatable in the direction indicated by the arrow. The roller supporter 62 moves the pressure roller 30 upward and downward, according to the position of the cam 63. The pressure spring 61a, which is attached to the roller supporter 62, extends or compresses along with the movement of the roller supporter 62.

In an exemplary operation, when the image forming apparatus 100 is in a waiting mode, the cam 63 is rotated to a first position. When the cam 63 is in the first position, the pressure roller 30 is positioned away from the fixing roller 28.

When the image forming apparatus 100 is activated, or switched from the waiting mode to an operating mode, such as by a user, the controller 42 sends a control signal to the driving source to rotate the fixing roller 28.

At the same time, the coil 56 of the heater 52 applies a current having a high frequency of about 20 kHz to 60 kHz to the surface of the fixing roller 28, which is rotatably driven. Alternative electric currents, for example direct current or three-phase current, may be used. The heat emitting layer 28 of the fixing roller 28 is self heated by the Joule heat caused by the eddy current.

When a predetermined time period passes, the controller 42 sends a control signal to the driving source. With this control signal, the cam 63 is rotated to a second position. When the cam 63 is in the second position, the roller supporter 62 moves the pressure roller 30 toward the fixing roller 21. The pressure spring 61a extends due to the reduced pressure from the roller supporter 62. As a result, the nip SN sufficient for fixing a toner image is formed between the fixing roller 28 and the pressure roller 30. Further, with the rotation of the fixing roller 28, the pressure roller 30 is rotated in conformance with the direction of rotation the fixing roller 28. The controller 42 then sends a control signal to start an image fixing operation. The paper P is then transferred to the nip SN.

In one exemplary embodiment, the above predetermined time period is a time needed for the surface temperature of the fixing roller 28 to increase to a temperature sufficient to melt toner. Information regarding this time period may be stored in the memory of the controller 42, for example.

Further, in another exemplary embodiment, the surface of the pressure roller 30 is made harder than the surface of the fixing roller 28. Thus, as shown in FIG. 2, the surface of the fixing roller 28 is deformed under the pressure from the pressure roller 30 at the nip SN. With this deformation, the paper P passing through the nip SN is curved to form a convex shape. With this convex shape, the paper P can be easily separated from the fixing roller 28 after the image fixing operation. Accordingly, the amount of pressure between the fixing roller 28 and the pressure roller 30 affects the size and shape of the nip SN.

In another exemplary operation, the controller 42 may wait for a predetermined time period, after the cam 63 is rotated at the second position and before the image fixing operation.

For example, the pressure roller 30, which is brought in contact with the fixing roller 28, is heated by the fixing roller 28. When a predetermined time period passes, the controller 42 sends a control signal to start an image fixing operation.

The above predetermined time period is a time needed for the temperature of the surface of the pressure roller 30 to increase to a temperature substantially equal to the surface temperature of the fixing roller 28. Although the term “surface” temperature is used, the temperature of other parts of the rollers may be used in some embodiments. Information regarding this time period may be stored in the memory of the controller 42, for example.

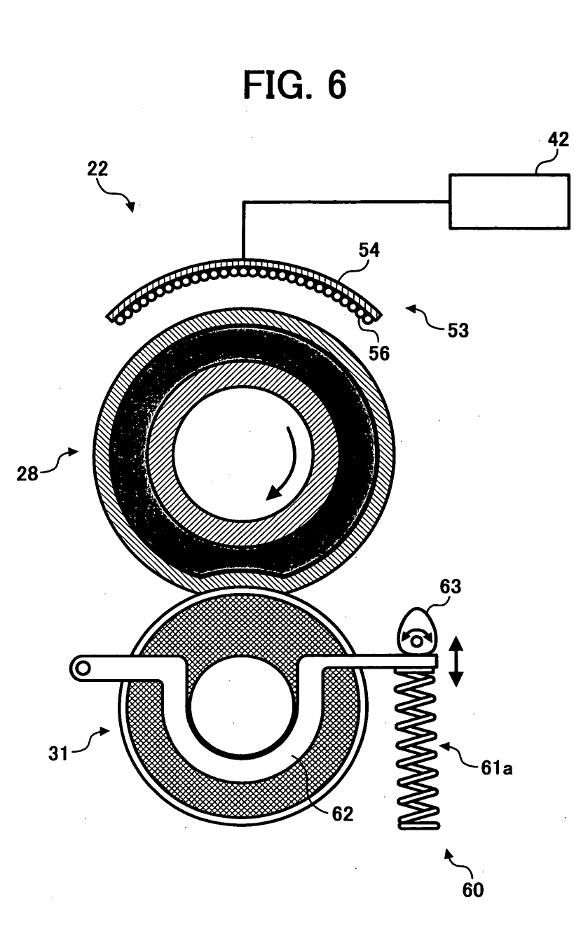

The fixing device 22 of FIG. 6 is substantially similar in structure to the fixing device 21 of FIG. 2. The differences include the heater 53 and the pressure roller 31.

In one non-limiting embodiment, the heater 53 is curved along the circumferential direction of the fixing roller 28. Further, the coil 56 is wound around the coil supporter 54, having a plate-like shape, in the axial direction of the fixing roller 28.

The pressure roller 31 is made of a plurality of layers, including the core 30a, the elastic layer 30b, and the releasing layer 30c, as shown in FIG. 5. In another non-limiting embodiment, the elastic layer 30b of the pressure roller 31 has a thickness of about 5 mm to 10 mm. Other thicknesses are possible, and a thicker elastic layer 30b may be used to better suppress heat transfer from the surface of the pressure roller 31 to the core 30a.

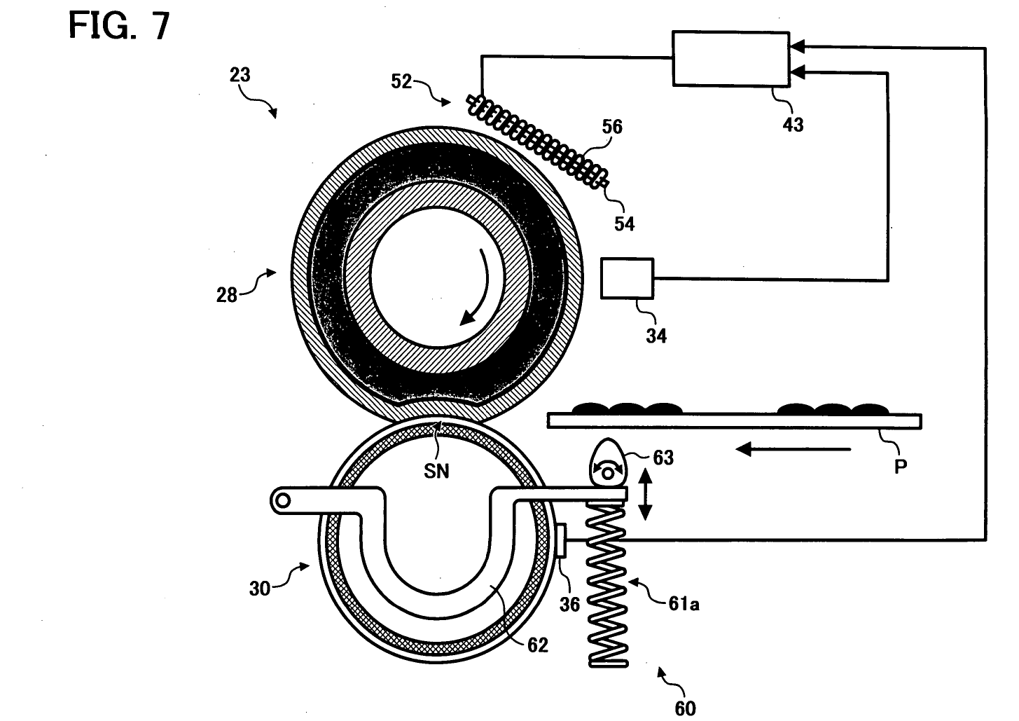

The fixing device 23 of FIG. 7 is substantially similar in structure to the fixing device 21 of FIG. 2. The differences include the fixing roller detector 34, the pressure roller detector 36, and the controller 43.

In this exemplary embodiment, the fixing roller detector 34 detects a surface temperature of the fixing roller 28. As shown in FIG. 7, the fixing roller detector 34 is provided remotely from the surface of the fixing roller 28. This allows the fixing roller detector 34 to detect a surface temperature of the fixing roller 28 without contacting the surface of the fixing roller 28. For this reason, the fixing roller detector 34 is preferably implemented by an infrared detector, such as a thermopile, for example.

Alternatively, the fixing roller detector 34 may be provided in contact with the surface of the fixing roller 28. However, this may accelerate wear of the fixing roller 28.

The pressure roller detector 36 is configured to detect a surface temperature of the pressure roller 30. As shown in FIG. 7, the pressure roller detector 36 may be provided in contact with the surface of the pressure roller 36, since the pressure roller 30 is made harder than the fixing roller 28 in this exemplary embodiment.

Alternatively, the pressure roller detector 36 may be provided remotely (physically separate) from the surface of the pressure roller 36, as long as it is capable of detecting the surface temperature.

In this exemplary embodiment, one fixing roller detector 34 and one pressure roller detector 36 are provided. However, the number of detectors is not limited to this example. It is preferable that at least the surface temperature of the fixing roller 28 can be measured, if not more of the fixing roller 28. Further, the positions of the detector 34 and 36 are not limited to the positions shown in FIG. 7.

The controller 43 is substantially similar in structure to the controller 42. However, the controller 43 may operate differently from the controller 42.

In an exemplary operation, when the image forming apparatus 100 is in waiting mode, the pressure roller 30 is positioned away from the fixing roller 28.

When the image forming apparatus 100 is activated, or switched from the waiting mode to the operating mode, the controller 43 sends a control signal to the driving source for rotating the fixing roller 28.

At the same time, the heater 56 applies heat to the fixing roller 28, which is rotatably driven, in a substantially similar manner as described referring to FIG. 2.

In one non-limiting embodiment, the fixing roller detector 34 constantly measures a surface temperature of the fixing roller 28, and the measured temperatures are checked by the controller 43. When the surface temperature reaches a predetermined temperature, the controller 43 sends a control signal to rotate the cam 63 to the second position. As a result, the pressure roller 30 moves upward toward the fixing roller 28, and forms the nip SN for an image fixing operation.

In one exemplary embodiment, the predetermined temperature is a temperature sufficient for melting toner. Information regarding this temperature may be stored in the memory of the controller 43, for example.

In addition, the controller 43 may additionally check a surface temperature of the pressure roller 30.

In yet another exemplary operation, the pressure roller detector 36 is configured to measure a surface temperature (or other temperature) of the pressure roller 30, and the measured temperatures are monitored by the controller 43. When the surface temperature of the pressure roller 36 reaches a predetermined temperature, typically a temperature approximately equal to the predetermined temperature of the fixing roller 28, the controller 43 sends a control signal to start an image fixing operation. Other temperatures above or below the temperature of the fixing roller 28 may also be used.

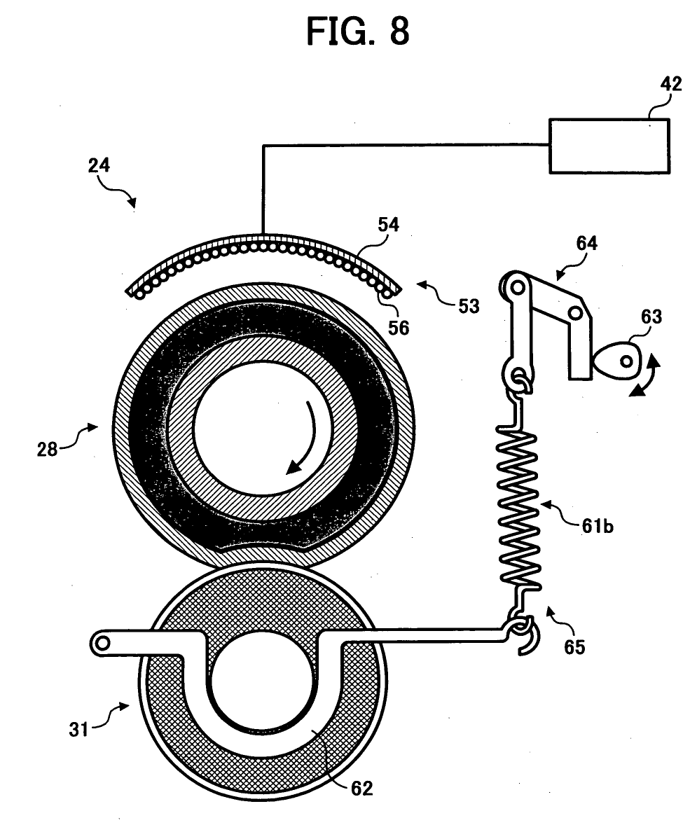

The fixing device 24 of FIG. 8 is substantially similar in structure to the fixing device 22 of FIG. 6. The differences include the pressure controller 65.

The pressure controller 65 is capable of controlling a pressure generated at a nip formed between the fixing roller 28 and the pressure roller 31. As shown in FIG. 8, the pressure controller 65 includes a pressure spring 61b, the roller supporter 62, the cam 63, and a pressure lever 64.

The cam 63 is rotatable in the direction indicated by the arrow. The pressure lever 64 is configured to move upward or downward, according to the position of the cam 63. The pressure spring 61b, which connects the pressure lever 64 and the roller supporter 62, extends or compresses according to the movement of the pressure lever 64. The roller supporter 62 is configured to move upward or downward, according to the extension or compression of the pressure spring 61b.

When the cam 63 is moved to the first position upon receiving a control signal from the controller 42, the pressure lever 64 is moved downward and compresses the spring 61b. The compressed spring 61b moves the pressure roller 31 slightly away from the fixing roller 28.

When the cam 63 is moved to the second position upon receiving a control signal from the controller 42, the pressure lever 64 is moved upward, and extends the spring 61b. The extended spring 61b moves the pressure roller 31 slightly toward the fixing roller 28.

In one exemplary embodiment, the fixing roller 28 and the pressure roller 30 need not be completely separated when the cam 63 is moved to the first position, as long as the pressure generated between the rollers at the nip SN is reduced. In other embodiments, the fixing roller 28 and pressure roller 30 may be completely separated when the cam 63 is moved to the first position.

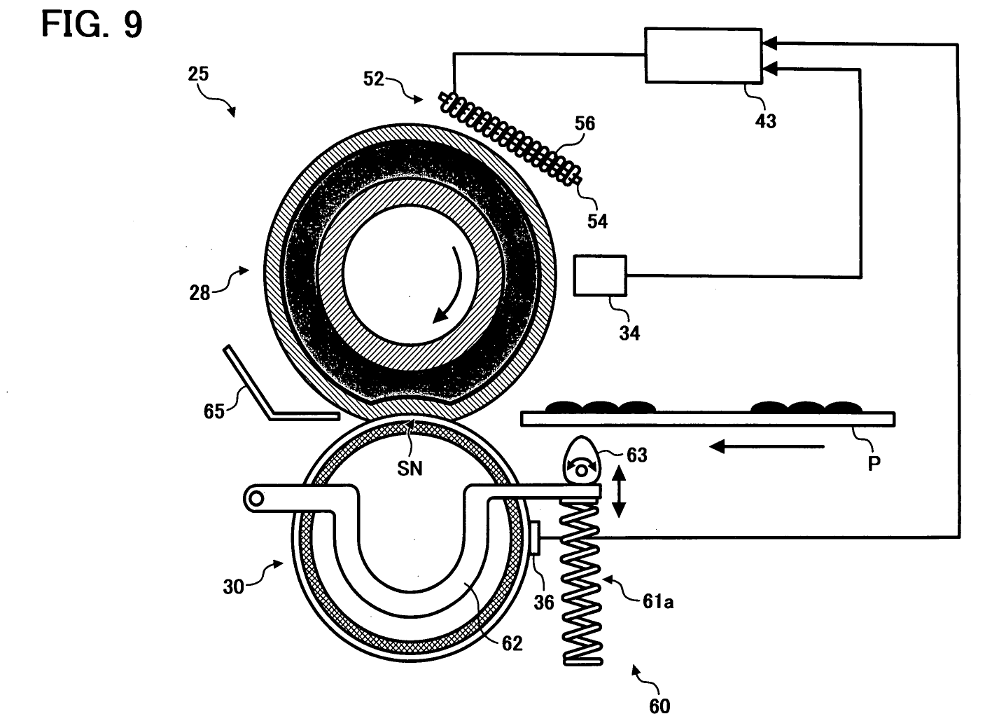

The fixing device 25 of FIG. 9 is substantially similar in structure to the fixing device 23 of FIG. 7. The differences include the separator 65.

The separator 65 separates the paper P, which has passed through the nip SN, from the fixing roller 28. As shown in FIG. 9, the separator 65 is located separately from the surface of the fixing roller 28 and in parallel to the nip SN.

Alternatively, the separator 65 may be provided in contact with the surface of the fixing roller 28. However, this may accelerate wear of the fixing roller 28.

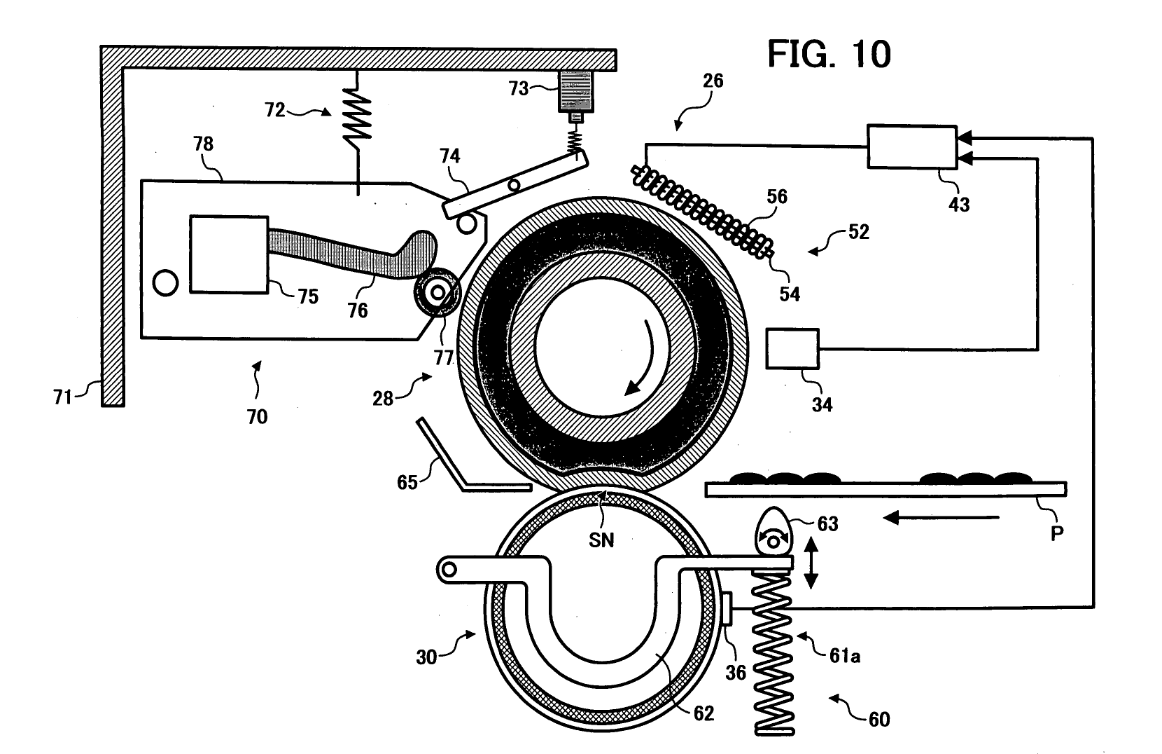

The fixing device 26 of FIG. 10 is substantially similar to the fixing device 23 of FIG. 7. The differences include the releasing agent applying member 70, which applies a releasing agent to the surface of the fixing roller 28. In this exemplary embodiment, the releasing layer 28e may not be provided.

As shown in FIG. 10, the applying member 70 includes a frame 71, a spring 72, a solenoid 73, a swinging member 74, and a casing 78 having a tank 75, a supplier 76, and an applying roller 77.

The tank 75 stores a releasing agent, such as a releasing agent having silicon oil. The supplier 76, which is made of felt, has one end dipped into the tank 75 and the other end contacting the surface of the applying roller 77. The applying roller 77 applies the releasing agent, supplied by the supplier 76, to the surface of the fixing roller 28. The tank 75, the supplier 76, and the applying roller 77 are accommodated in the casing 78.

The frame 71 is fixed at a predetermined position in the fixing device 26.

The spring 72 has one end attached to the frame 71 and the other end attached to the casing 78.

The solenoid 73 has one end surface attached to the frame 71, and the other end connected to the swinging member 74 via a flexible member, such as a spring.

The swinging member 74, which is attached to the casing 78, pivots at its center.

When the solenoid 73 has no current flow, the end of the swinging member 74 in contact with the casing 78 moves upward, while compressing the spring 72. The compressed spring 72 and the swinging member 74 hold the casing 78 away from the surface of the fixing roller 28.

When the solenoid 73 is energized, the part of swinging member 74 attached to the casing 78 moves downward while extending the spring 72. The extended spring 72 and the swinging member 74 move the position of the casing 78 toward the surface of the fixing roller 28.

In an exemplary operation, when the image forming apparatus 100 is in waiting mode, the solenoid 73 is not energized. Thus, the applying roller 77 is kept away from the surface of the fixing roller 28.

When the image forming apparatus 100 is activated, or switched from waiting mode to an operating mode, such as by a user, the controller 42 causes the fixing roller 28 to rotate, as described referring to FIG. 2, for example. At the same time, the controller 42 sends a control signal for sending a current to the solenoid 73. The applying roller 77 is moved to a position in contact with the surface of the fixing roller 28 to apply a releasing agent to the fixing roller 28.

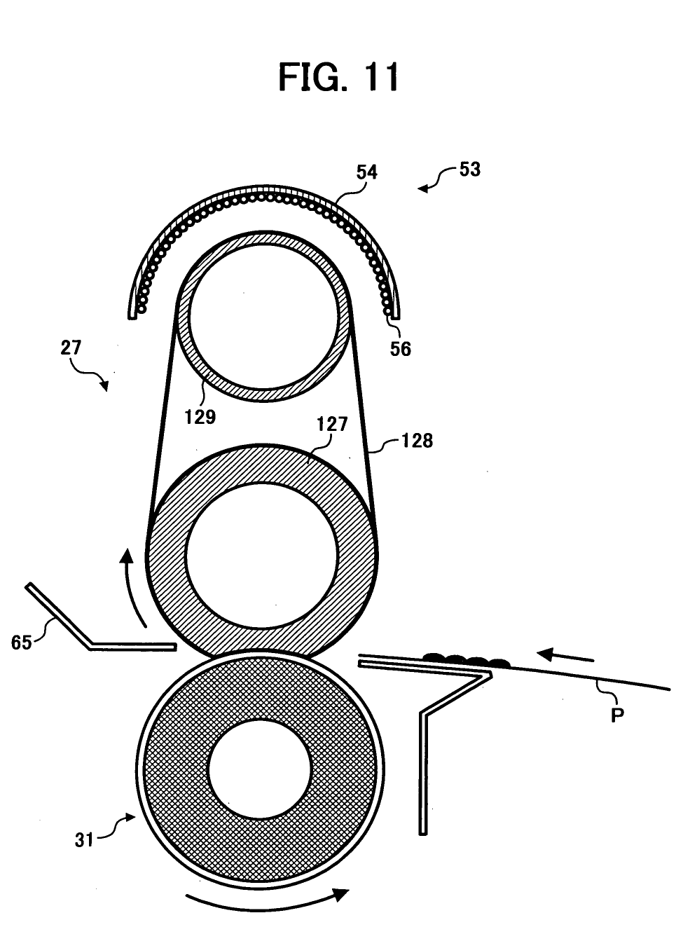

The above-described fixing devices or other fixing devices of the present invention may be implemented to have a fixing belt, for example, as illustrated in FIG. 11.

The fixing device 27 of FIG. 11 includes a fixing belt 128, a roller 129, an elastic roller 127, the pressure roller 31, the heater 53, and the separator 65. In this exemplary embodiment, the fixing belt 128 is heated by the heater 54, while rotating around the roller 129 and the elastic roller 127.

Numerous additional modifications and variations are possible in light of the above teachings. It is therefore to be understood that within the scope of the appended claims, the disclosure of this patent specification may be practiced otherwise than as specifically described herein.

For example, elements and/or features of different illustrative embodiments may be combined with each other and/or substituted for each other within the scope of this disclosure and appended claims.

Further, in any one of the above-described exemplary embodiments, the controller may control an operation of the fixing device, by switching operation modes of the fixing device.

For example, when the fixing device is in a waiting mode, the cam is at the first position. Accordingly, the pressure roller is kept away from the fixing roller.

The fixing device may then be switched from the waiting mode to a warm-up mode. In the warm-up mode, the fixing roller is rotated, and heated by the heater.

The fixing device may then be switched from the warm-up mode to a fixing mode when a predetermined time period passes or when a surface temperature of the fixing roller reaches a predetermined value. In the fixing mode, the cam is rotated to the second position. Accordingly, the pressure roller is moved toward the fixing roller. Subsequently, an image fixing operation is performed.

In another embodiment, the fixing device may be switched from the waiting mode to a first warm-up mode. In the first warm-up mode, the fixing roller is rotated, and heated by the heater.

The fixing device is then switched from the first warm-up mode to a second warm-up mode, when a predetermined time period passes or when a surface temperature of the fixing roller reaches a predetermined value. In the second warm-up mode, the cam is rotated to the second position. Accordingly, the pressure roller is moved toward the fixing roller, and starts rotating along with the rotation of the fixing roller.

The fixing device is switched from the second warm-up mode to a fixing mode when a predetermined time period passes or when a surface temperature of the pressure roller reaches a predetermined value. In the fixing mode, an image fixing operation is performed.

Furthermore, in any one of the above-described exemplary embodiments, a pressure controller may be provided to move the position of the fixing roller.

Furthermore, any one of the image fixing operations mentioned above may be embodied in the form of a computer program. In such a case, the computer program is preferably stored in a storage device readable by the CPU of the controller. The storage device includes any kind of memory, such as a built-in memory installed inside an image forming apparatus or a removable memory separable from the image forming apparatus. Alternatively, the computer program may be downloaded via a network to be stored in the storage device.

Obviously, numerous modifications and variations of the present invention are possible in light of the above teachings. It is therefore to be understood that within the scope of the appended claims, the invention may be practiced otherwise than as specifically described herein.

1. A fixing device, comprising:
a fixing member;
a pressure member, facing the fixing member, configured to form a nip with the fixing member;
a heater configured to heat a surface of the fixing member at a position on the fixing member other than at the nip when the fixing member rotates; and
a pressure controller configured to change a pressure generated at the nip, according to an operation of the fixing device.

2. The fixing device of claim 1, wherein the pressure controller is configured to further change a size of the nip.

3. The fixing device of claim 1, further comprising:
a detector configured to detect a surface temperature of the fixing device.

4. The fixing device of claim 3, wherein the detector is physically separate from the fixing member.

5. The fixing device of claim 1, further comprising:
a separator configured to separate the recording medium from the fixing member.

6. The fixing device of claim 5, wherein the separator is physically separate from the fixing member.

7. The fixing device of claim 1, further comprising:
a releasing agent applying member configured to change position relative to the fixing member, in conjunction with the pressure controller.

8. The fixing device of claim 1, wherein the fixing member includes:
a core;
a heat absorbing layer formed on the core and configured to suppress heat transmission to the core from the exterior of the roller;
a heat emitting layer formed on the heat absorbing layer and configured to generate heat; and
an elastic layer formed on the heat emitting layer and configured to foster heat transmission from the heat emitting layer.

9. A fixing device, comprising:
a controller configured to switch operation modes of the fixing device between a waiting mode and an operating mode;
a fixing member configured to rotate in the operating mode;
a pressure member, facing the fixing member, configured to form a nip with the fixing member;
a heater configured to heat a surface of the fixing member in the operating mode;
a pressure controller configured to change a pressure generated at the nip when the operation modes are switched.

10. The image fixing device of claim 9, wherein the operating modes include a warm-up mode and a fixing mode.

11. The image fixing device of claim 10, wherein the pressure controller is configured to change the pressures generated at the nip portion between each of the waiting mode, the warm-up mode, and the fixing mode, and the pressures generated at the nip during each of the waiting and warm-up modes are less than the pressure generated during the fixing mode.

12. The image fixing device of claim 11, wherein the warm-up mode is switched to the fixing mode when a surface temperature of the fixing member reaches a predetermined value.

13. The image fixing device of claim 11, wherein the warm-up mode is switched to the fixing mode when a predetermined amount of time passes after switching to the warm-up mode.

14. The image fixing device of claim 9, wherein the operating modes include a first warm-up mode, a second warm-up mode, and a fixing mode.

15. The image fixing device of claim 14, wherein the pressure controller is configured to change the pressure generated at the nip between the waiting mode, the first warm-up mode, the second warm-up mode and the fixing mode, and the pressure generated in each of the waiting and first warm-up modes is less than the pressure generated in each of the second warm-up mode and the fixing mode.

16. The image fixing device of claim 15, wherein the first warm-up mode is switched to the second warm-up mode when a temperature of the fixing member reaches a predetermined value.

17. The image fixing device of claim 16, wherein the second warm-up mode is switched to the fixing mode when a temperature of the pressure member reaches a predetermined value.

18. The image fixing device of claim 15, wherein the first warm-up mode is switched to the second warm-up mode after a predetermined amount of time passes after switching to the first warm-up mode.

19. The image fixing device of claim 18, wherein the second warm-up mode is switched to the fixing mode after a predetermined amount of time passes after switching to the second warm-up mode.

20. An image forming apparatus, comprising the fixing device of claim 1.

21. An image forming apparatus, comprising the fixing device of claim 9.

22. An image fixing method, comprising:
providing a fixing member and a pressure member facing each other to form a nip;
rotating the fixing member;
heating a surface of the fixing member to a predetermined temperature value;
moving at least one of the fixing member and the pressure member to change a pressure generated at the nip.

23. The image fixing method of claim 22, further comprising:
fixing a toner image on a recording medium at the nip.

24. The image fixing method of claim 23, further comprising:
heating a surface of the pressure member to the predetermined temperature value before the fixing step.

25. An image fixing device, comprising:
means for fixing a toner image to a recording medium;
means for forming a nip with the fixing means;
means for heating a surface of the fixing means to a predetermined temperature; and
means for changing a pressure generated at the nip.

26. A computer program, adapted to, when executed on a computer, cause the computer to carry out the method of claim 22.

27. The computer program product, including the computer program of claim 26.
